(19) United States
(12) Patent Application Publication
(10) Pub. No.: US 2012/0318428 A1
(43) Pub. Date: Dec. 20, 2012

(54) Tire Comprising Carcass Reinforcement Cables Having Different Degrees of Permeability

(75) Inventor: Alain Domingo, Orleat (FR)

(73) Assignees: Michelin Recherche et Technique S.A., Granges-Paccot (CH); COMPAGNIE GENERALE DES ETABLISSEMENTS MICHELIN, Clermont-Ferrand (FR)

(21) Appl. No.: 13/513,826

(22) PCT Filed: Nov. 29, 2010
(86) PCT No.: PCT/EP2010/068408

§ 371 Date: Aug. 14, 2012

(30) Foreign Application Priority Data
Dec. 4, 2009 (FR) 0958652

(51) Int. Cl. B60C 9/13

(52) U.S. Cl. 152/556; 152/557

(57) ABSTRACT

A tire having a radial carcass reinforcement, including at least one layer of reinforcing elements, said tire comprising a crown reinforcement, which is itself covered radially with a tread, said tread being joined to two beads via two sidewalls, wherein at least 85% of the reinforcing elements of at least one layer of the carcass reinforcement are non-wrapped metal cords having in what is called the permeability test a flow rate of less than 20 cm3/min, and in that at least 5% of the reinforcing elements of said at least one layer of the carcass reinforcement are cords comprising at least one strand consisting of textile multifilament yarns.

The present invention relates to a tire having a radial carcass reinforcement and more particularly to a tire intended to equip heavy-goods vehicles running at sustained speed, such as, for example, lorries, tractors, trailers or buses.

In general in heavy-goods vehicle tires, the carcass reinforcement is anchored on either side in the region of the bead and is surmounted radially by a crown reinforcement consisting of at least two superposed layers formed from threads or cords that are parallel in each layer and crossed from one layer to the next, making angles of between 10° and 45° with the circumferential direction. Said working layers, forming the working reinforcement, may further be covered with at least one protective layer formed from advantageously extensible metal reinforcing elements, called elastic elements. It may also comprise a layer of low-extensibility metal threads or cords making an angle of between 45° and 90° with the circumferential direction, this ply, called triangulation ply, being located radially between the carcass reinforcement and the first crown ply called the working ply, these being formed from parallel threads or cords at angles of at most equal to 45° in absolute value. The triangulation ply forms, with at least said working ply, a triangulated reinforcement which undergoes, when subjected to the various stresses, little deformation, the essential role of the triangulation ply being to take up the transverse compressive forces to which all of the reinforcing elements in the crown region of the tire are subjected.

In the case of heavy-goods vehicle tires, a single protective layer is usually present and its protecting elements are, in most cases, oriented in the same direction and at the same angle in absolute value as those of the reinforcing elements of the radially outermost, and therefore radially adjacent, working layer. In the case of civil engineering vehicle tires, intended for running on more or less uneven ground, the presence of two protective layers is advantageous, the reinforcing elements being crossed from one layer to the next and the reinforcing elements of the radially inner protective layer being crossed with the inextensible reinforcing elements of the radially outer working layer adjacent to said radially inner protective layer.

The circumferential direction, or longitudinal direction, of the tire is the direction corresponding to the periphery of the tire and defined by the running direction of the tire.

The transverse or axial direction of the tire is parallel to the rotation axis of the tire.

The radial direction is a direction cutting the rotation axis of the tire and perpendicular thereto.

The rotation axis of the tire is the axis about which it rotates in normal use.

A radial or meridian plane is a plane that contains the rotation axis of the tire.

The circumferential median, or equatorial, plane is a plane perpendicular to the rotation axis of the tire and that divides the tire into two halves.

Certain current “road” tires are intended to run at high speed on increasingly long journeys, because of the improvements in road networks and the growth of motorway networks throughout the world. All the conditions, under which such a tire is called upon to run, without doubt enable the tire to be run for a larger number of kilometers, since the wear of the tire is less. However, the endurance of this tire is prejudiced. To permit one or even two retreading operations on such tires, so as to extend their lifetime, it is necessary to preserve a structure and especially a carcass reinforcement with endurance properties which are sufficient to withstand said retreading operations.

Prolonged running under particularly severe conditions of tires thus constructed effectively introduces limits in terms of endurance of these tires.

The elements of the carcass reinforcement are in particular subjected to flexural and compressive stresses during running which adversely affect their endurance. The cords that make up the reinforcing elements of the carcass layers are in fact subjected to large stresses when the tires are running, especially to repeated flexural stresses or variations in curvature, leading to friction between the threads, and therefore wear and fatigue: this phenomenon is termed “fatigue fretting”.

To fulfill their function of strengthening the carcass reinforcement of the tire, said cords must firstly have good flexibility and a high endurance in flexure, which means in particular that their threads have to have a relatively small diameter, preferably less than 0.28 mm, more preferably less than 0.25 mm, generally smaller than that of the threads used in conventional cords for the crown reinforcements of tires.

The cords of the carcass reinforcement are also subject to the phenomenon of “fatigue-corrosion” due to the very nature of the cords, which promote the passage of corrosive agents such as oxygen and moisture or even drain said agents. Specifically, air or water penetrating the tire, for example as a result of degradation following a cut or more simply because of the permeability, albeit low, of the inner surface of the tire, may be conveyed by the channels formed within the cords because of their very structure.

All these fatigue phenomena, which are generally grouped together under the generic term “fatigue-fretting-corrosion”, are the cause of progressive degradation of the mechanical properties of the cords and may, under the severest running conditions, affect the lifetime of said cords.

To improve the endurance of these cords of the carcass reinforcement, it is known in particular to increase the thickness of the rubber layer that forms the internal wall of the cavity of the tire in order to minimize the permeability of said layer. This layer is usually composed partly of butyl rubber so as to better seal the tire. This type of material has the drawback of increasing the cost of the tire.

It is also known to modify the construction of said cords so as in particular to increase their penetrability by the rubber and thus limit or even eliminate the passage of oxidizing agents via the channels formed within the cords. Tires produced in this way have revealed problems of air pockets appearing during manufacture of the tire.

This is because the various manufacturing steps lead to the formation of occluded air pockets. In the case of tires comprising a carcass reinforcement formed from cords having a structure that forms channels able to conduct the air, these air pockets disappear owing to the diffusion of the air into the materials, especially through said channels existing within the cords. In the case of tires comprising a carcass reinforcement formed from cords having a structure which is highly penetrated by the rubber, these air pockets remain after the manufacturing steps. What appears is only a displacement of these air pockets during the step of curing the tire, said pockets being displaced towards regions where a low pressure is exerted. The displacement of the air takes place along the carcass reinforcement, along passages that exist between the reinforcing elements, the layers of rubber compound covering the reinforcing elements forming indentation zones parallel to the reinforcing elements before the step of curing the tire. These indentation zones thus to permit the air to move slightly depending on the pressure that is exerted on the regions where the air pockets exist. The pressure or the pressure variations occur especially during the step of curing the tire or else during the conforming step, if it exists.

The appearance of these air pockets is usually unacceptable depending on their location, and may require scrapping the tires, as said air pockets may become zones of weakness in the tire. The manufacturing costs therefore become unacceptable simply because of the poor production yields.

The inventors were thus tasked with providing heavy-goods vehicles with tires the wear performance of which is maintained for road usage and in particular the endurance performance of which is improved, especially with regard to “fatigue-corrosion” or “fatigue-fretting-corrosion” phenomena, irrespective of the running conditions, in particular in terms of inflation, the manufacturing cost of said tires remaining acceptable.

This objective has been achieved according to the invention by a tire having a radial carcass reinforcement, consisting of at least one layer of reinforcing elements, said tire comprising a crown reinforcement, which is itself covered radially with a tread, said tread being joined to two beads via two sidewalls, at least 85% of the metal reinforcing elements of at least one layer of the carcass reinforcement being non-wrapped metal cords having in what is called the permeability test a flow rate of less than 20 cm³/min and at least 5% of the reinforcing elements of said at least one layer of the carcass reinforcement being cords comprising at least one strand consisting of textile multifilament yarns.

The cords are either stranded cords or layered cords, or stranded cords of layered cords, or layered cords comprising strands.

Stranded cords are cords consisting of strands or threads twisted together.

Layered cords or multi-layer cords are cords consisting of a central core and one or more practically concentric layers of strands or threads placed around this central core.

The layered cords most often used in the carcasses of heavy-goods vehicle tires are cords of [L+M] or [L+M+N] construction, the latter being generally intended for the largest tires. These cords are formed in a known manner from a core of L threads surrounded by a layer of M threads, the L+M combination forming the core of the cord, which core is itself surrounded by an outer layer of N threads, with in general L varying from 1 to 4, M varying from 3 to 12, and N varying from 8 to 20. Where appropriate, the assembly may be wrapped with an external wrapping thread wound in a helix around the final layer.

The cords are obtained from strands or threads consisting of multifilament yarns, which strands or yarns may or may not be twisted together, or from unitary threads such as cylindrical or oblong monofilaments, which may or may not be twisted together.

The cords may be of hybrid type, that is to say composite, when they comprise elements of different nature.

According to a preferred embodiment of the invention, the textile multifilament yarns are of the polyamide type and more preferably of the aromatic polyamide type, so as to provide mechanical properties as close as possible to those of the metal threads.

Although aliphatic polyamides are not excluded, they have in certain cases drawbacks, especially owing to possible shrinkage phenomena.

In what is called the permeability test it is possible to determine longitudinal permeability to air of the tested cords, by measuring the volume of air passing through a test specimen under constant pressure for a given time. The principle of such a test, well known to those skilled in the art, is to demonstrate the effectiveness of the treatment of a cord for making it impermeable to air. The test has been described for example in the standard ASTM D2692-98.

The test is carried out on cords directly extracted, by stripping, from the vulcanized rubber plies that they reinforce, and therefore on cords that have been penetrated by cured rubber.

The test is carried out on a 2 cm length of cord, and therefore coated with its surrounding rubber composition (or coating rubber) in the cured state, in the following manner: air is sent into the cord, under a pressure of 1 bar, and the volume of air leaving it is measured using a flowmeter (calibrated for example from 0 to 500 cm³/min). During the measurement, the cord specimen is blocked in a compressed seal (for example a seal made of dense foam or rubber) in such a way that only the amount of air passing through the cord from one end to the other, along its longitudinal axis, is taken into account in the measurement. The sealing provided by the seal itself is checked beforehand using a solid rubber test specimen, that is to say one without a cord.

The measured average air flow rate (average over 10 test specimens) is lower the higher the longitudinal impermeability of the cord. Since the measurement is made with an accuracy of ±0.2 cm³/min, the measured values equal to or less than 0.2 cm³/min are considered to be zero and correspond to a cord that may be termed airtight (completely airtight) along its axis (i.e. in its longitudinal direction).

This permeability test also constitutes a simple means of indirectly measuring the degree of penetration of the cord by a rubber composition. The measured flow rate is lower the higher the degree of penetration of the cord by the rubber.

Cords having in what is called the permeability test a flow rate of less than 20 cm³/min have a degree of penetration greater than 66%.

Cords having in what is called the permeability test a flow rate of less than 20 cm³/min have a degree of penetration greater than 90%.

The degree of penetration of a cord may also be estimated using the method described below. In the case of a layered cord, the method consists firstly in removing the outer layer on a specimen having a length between 2 and 4 cm and then measuring, along a longitudinal direction and along a given axis, the sum of the lengths of rubber compound divided by the length of the specimen. These rubber compound length measurements exclude the spaces not penetrated along this longitudinal axis. These measurements are repeated along three longitudinal axes distributed over the periphery of the specimen and repeated on five cord specimens.

When the cord comprises several layers, the first, removal step is repeated with the newly external layer and the rubber compound lengths measured along longitudinal axes.

All the ratios of rubber compound lengths to specimen lengths thus determined are then averaged so as to define the degree of penetration of the cord.

The inventors have demonstrated that a tire produced in this way according to the invention leads to very advantageous improvements in terms of the compromise between endurance and manufacturing cost. Indeed, the endurance properties of such a tire are equivalent to those of the solutions mentioned above. The presence of at least 85% of cords of the carcass reinforcement having a flow rate of less than 20 cm³/min in what is called the permeability test make it possible to limit the risks due to corrosion. Furthermore, the presence of at least 5% of cables comprising at least one strand consisting of textile multifilament yarns makes it possible to drain the occluded air during manufacture of the tire and therefore results in higher productivity than that mentioned above and therefore lower costs. The inventors have demonstrated that a number of cords comprising at least one strand consisting of textile multifilament yarns of between 5 and 15% makes it possible for the occluded air to meet a “drain” either right from the formation of an air pocket or upon said air pocket being displaced along a direction parallel to the reinforcing elements of the carcass reinforcement layer during the steps of manufacturing the tire, as was mentioned previously. The tests carried out have confirmed that the results obtained with cords comprising at least one strand consisting of textile multifilament yarns in these amounts are out of all proportion with those obtained with carcass reinforcement layers comprising only cords having in what is called the permeability test a flow rate of less than 20 cm³/min. This is because the presence of at least 5% of cords comprising at least one strand consisting of textile multifilament yarns makes it possible to maintain practically all the tires thus manufactured and therefore to bring the manufacturing unit cost back down to acceptable values.

According to a first embodiment of the invention, said at least 5% of cords comprising at least one strand consisting of textile multifilament yarns are textile cords, that is to say they consist only of textile strands or threads. According to this embodiment, their number is preferably less than 10% of the reinforcing elements of said at least one layer of the carcass reinforcement.

According to a second embodiment of the invention, said at least 5% of the cores are hybrid cords comprising textile strands or threads and metal strands or threads. The presence of at least a part of metal strands or threads in said at least 5% of cords makes it possible to provide mechanical properties closer to those of a metal cord. According to this second embodiment, their number is preferably greater than 10% of the reinforcement elements of said at least one layer of the carcass reinforcement in order to ensure that the occluded air is completely drained during the manufacturing phase.

Preferably again, according to this second embodiment of the invention, said at least 5% of the reinforcing elements of said at least one layer of the carcass reinforcement are hybrid layered cords, the core of which comprises at least one strand or thread consisting of textile multifilament yarns, the strands of the intermediate and/or outer layers being metal strands.

Preferably again, said at least 5% of the reinforcing elements of said at least one layer of the carcass reinforcement are hybrid cords of the 1+M+N type, that is to say the core corresponds to a single thread or strand consisting of textile multifilament yarns, the strands of the intermediate and outer layers being metal strands.

Again advantageously, according to this second embodiment of the invention, said at least 85% of cords of the carcass reinforcement having in what is called the permeability test a flow rate of less than 20 cm³/min are metal layered cords of the same construction as said at least 5% of hybrid cords.

In the case of a carcass reinforcement comprising several layers of reinforcing elements, each of said layers may be in accordance with the invention. Advantageously at least the radially outer layer comprises at least 85% of non-wrapped metal cords having in what is called the permeability test a flow rate of less than 20 cm³/min and at least 5% of cords comprising at least one strand consisting of textile multifilament yarns. This choice is particularly advantageous for ensuring complete evacuation of the air pockets that form during manufacture of the tire, these essentially appearing on the axially and/or radially external surface of the carcass reinforcement during manufacture.

According to one advantageous embodiment of the invention, said at least 85% of the metal reinforcing elements of at least one layer of the carcass reinforcement are cords having at least two layers, at least one inner layer being sheathed with a layer to consisting of a polymeric composition such as a crosslinkable or crosslinked rubber composition, preferably one based on at least one diene elastomer.

Again preferably according to the invention, the cords of the carcass reinforcement have in what is called the permeability test a flow rate of less than 10 cm³/min and more preferably less than 2 cm³/min.

The invention also provides a tire having a radial carcass reinforcement consisting of at least one layer of reinforcing elements, said tire comprising a crown reinforcement, which is itself covered radially with a tread, said tread being joined to two beads via two sidewalls, at least 85% of the reinforcing elements of at least one layer of the carcass reinforcement being non-wrapped metal cords having at least two layers, at least one inner layer being sheathed with a layer consisting of a polymeric composition such as a crosslinkable or crosslinked rubber composition, preferably one based on at least one diene elastomer, and at least 5% of the reinforcing elements of said at least one layer of the carcass reinforcement being cords comprising at least one strand consisting of textile multifilament yarns.

Again advantageously according to the invention, the hybrid cords are cords having at least three layers, at least one intermediate layer being sheathed with a layer consisting of a polymeric composition such as a crosslinkable or crosslinked rubber composition, preferably one based on at least one diene elastomer. In particular when the strands of the intermediate and outer layers are metal strands, the layer consisting of a polymeric composition prevents any rubbing between the metal strands or threads of the various layers.

The expression “composition based on at least one diene elastomer” is understood to mean, as is known, that the composition comprises predominantly (i.e. with a mass fraction greater than 50%) this or these diene elastomers.

It should be noted that the sheath according to the invention extends continuously around the layer that it covers (that is to say this sheath is continuous in the “orthoradial” direction of the cord, which is perpendicular to its radius) so as to form a continuous sleeve having a cross section that is advantageously almost circular.

It should also be noted that the rubber composition of this sheath is crosslinkable or crosslinked, that is to say it includes, by definition, a suitable crosslinking system thus allowing the composition to crosslink while it undergoes curing (i.e. it cures and does not melt). Thus, this rubber composition may be termed “non-melting”, because it cannot be melted by heating it to any temperature.

The term “diene” elastomer or rubber is understood, as is known, to mean an elastomer derived at least partly (i.e. a homopolymer or a copolymer) from diene monomers (monomers carrying two carbon-carbon double bonds, whether conjugated or not).

Diene elastomers, in a known manner, may be put into two categories: those called “essentially unsaturated” diene elastomers and those called “essentially saturated” diene elastomers. In general, an “essentially unsaturated” diene elastomer is understood here to mean a diene elastomer derived at least partly from conjugated diene monomers having an original content of diene units (conjugated dienes) which is greater than 15% (mol %). Thus, for example, diene elastomers such as butyl rubbers or copolymers of dienes and α-olefins of the EPDM type do not fall within the above definition and in particular can be termed “essentially saturated” diene elastomers (having an original content of diene units that is low or very low and always less than 15%). In the category of “essentially unsaturated” diene elastomers, the term “highly unsaturated” diene elastomer is understood to mean in particular a diene elastomer having an original content of diene units (conjugated dienes) of greater than 50%.

Given these definitions, a diene elastomer that can be used in the cord according to the invention is understood more particularly to mean:
(a) any homopolymer obtained by polymerizing a conjugated diene monomer having from 4 to 12 carbon atoms;
(b) any copolymer obtained by copolymerizing one or more conjugated dienes with one another or with one or more aromatic vinyl compounds having from 8 to 20 carbon atoms;
(c) a ternary copolymer obtained by copolymerizing ethylene, an α-olefin having 3 to 6 carbon atoms with an unconjugated diene monomer having from 6 to 12 carbon atoms, such as for example, the elastomers obtained from ethylene or propylene with an unconjugated diene monomer of the aforementioned type, such as for example 1,4-hexadiene, ethylidene norbornene and dicyclopentadiene;
(d) an isobutene/isoprene copolymer (butyl rubber), and also halogenated, in particular chlorinated or brominated versions of this type of copolymer.

Although it applies to any type of diene elastomer, the present invention is primarily implemented with essentially unsaturated diene elastomers, in particular of type (a) or (b) above.

Thus, the diene elastomer is preferably chosen from the group formed by polybutadienes (BR), natural rubber (NR), synthetic polyisoprenes (IR), various butadiene copolymers, various isoprene copolymers and blends of these elastomers. More preferably, such copolymers are chosen from the group formed by stirene-butadiene copolymers (SBR), butadiene-isoprene copolymers (BM), stirene-isoprene copolymers (SIR) and stirene-butadiene-isoprene copolymers (SBIR).

More preferably according to the invention, the diene elastomer chosen predominantly (i.e. in respect of more than 50 phr) consists of an isoprene elastomer. The term “isoprene elastomer” is understood to mean, as is known, an isoprene homopolymer or copolymer, in other words a diene elastomer chosen from the group formed by natural rubber (NR), synthetic polyisoprenes (IR), various isoprene copolymers and blends of these elastomers.

According to one advantageous embodiment of the invention, the diene elastomer chosen consists exclusively (i.e. for 100 phr) of natural rubber, synthetic polyisoprene or a blend of these elastomers, the synthetic polyisoprene having a content (in mol %) of 1,4-cis bonds preferably greater than 90%, and even more preferably greater than 98%.

It would also be possible to use, according to one particular embodiment of the invention, cuts (blends) of this natural rubber and/or these synthetic polyisoprenes with other highly unsaturated diene elastomers, especially with SBR or BR elastomers as mentioned above.

The rubber sheath of the cord of the invention may contain one or more diene elastomers, it being possible for these to be used in combination with any type of synthetic elastomer other than those of diene type, or even with polymers other than elastomers, for example thermoplastic polymers, these polymers other than elastomers then being present by way of minority polymer.

Although the rubber composition of said sheath is preferably devoid of any plastomer and contains only a diene elastomer (or blend of diene elastomers) as polymeric base, said composition could also include at least one plastomer with a mass fraction xₚ which is less than the mass fraction xₑ of the elastomer(s). In such a case, the following relationship preferably applies: 0<xₚ<0.5xₑ and more preferably the following relationship applies: 0<xₚ<0.1xₑ.

Preferably, the crosslinking system of the rubber sheath is a system called a vulcanization system, that is to say one based on sulphur (or on a sulphur donor) and a primary vulcanization accelerator. Added to this base vulcanization system may be various known secondary vulcanization accelerators or vulcanization activators. Sulphur is used with a preferential amount of between 0.5 and 10 phr, more preferably between 1 and 8 phr, and the primary vulcanization accelerator, for example a sulphonamide, is used with a preferential amount of between 0.5 and 10 phr, more preferably between 0.5 and 5.0 phr.

The rubber composition of the sheath according to the invention includes, besides said crosslinking system, all the common ingredients that can be used in rubber compositions for tires, such as reinforcing fillers based on carbon black and/or an inorganic reinforcing filler such as silica, anti-ageing agents, for example antioxidants, extender oils, plasticizers or processing aids, which make it easier to process the compositions in the uncured state, methylene donors and acceptors, resins, bismaleimides, known adhesion promoter systems of the RFS (resorcinol-formaldehyde-silica) type or metal salts, especially cobalt salts.

Preferably, the composition of the rubber sheath has, in the crosslinked state, a secant modulus in extension with 10% elongation (denoted M10), measured according to the ASTM D 412 (1998) standard, of less than 20 MPa and more preferably less than 12 MPa, in particular between 4 and 11 MPa.

Preferably, the composition of this sheath is chosen to be the same as the composition used for the rubber matrix that the cords according to the invention are intended to reinforce. Thus, there is no problem of any incompatibility between the respective materials of the sheath and the rubber matrix.

Preferably, said composition is based on natural rubber and contains carbon black as reinforcing filler, for example a carbon black of ASTM 300, 600 or 700 grade (for example N326, N330, N347, N375, N683 or N772).

According to a variant of the invention, said at least 85% of cords of at least one layer of the carcass reinforcement having in what is called the permeability test a flow rate of less than 20 cm³/min are layered metal cords of [L+M] or [L+M+N] construction, comprising a first layer C1 having L threads of diameter d₁ where L ranges from 1 to 4, surrounded by at least one intermediate layer C2 having M threads of diameter d₂ wound together in a helix with a pitch p₂ where M ranges from 3 to 12, said layer C2 being optionally surrounded by an outer layer C3 of N threads of diameter d₃ wound together in a helix with a pitch p₃ where N ranges from 8 to 20, a sheath consisting of a crosslinkable or crosslinked rubber composition based on at least one diene elastomer covering, in the [L+M] construction, said first layer C1 and, in the [L+M+N] construction, at least said layer C2.

Preferably, the diameter of the threads of the first layer of the inner layer (C1) is between 0.10 and 0.5 mm and the diameter of the threads of the outer layers (C2, C3) is between 0.10 and 0.5 mm.

More preferably, the helix pitch with which said threads of the outer layer (C3) are wound is between 8 and 25 mm.

Within the meaning of the invention, the pitch represents the length, measured parallel to the axis of the cord, at the end of which a thread having this pitch makes one complete turn around the axis of the cord; thus, if the axis is sectioned by two planes perpendicular to said axis and separated by a length equal to the pitch of a thread of a to constituent layer of the cord, the axis of this thread in these two planes has the same position on the two circles corresponding to the layer of the thread in question.

Advantageously, the cord has one, and more preferably still all of the following characteristics, which is/are satisfied:
the layer C3 is a saturated layer, that is to say there exists insufficient space in this layer to add to it at least an (N+1)th thread of diameter d₃, N then representing the maximum number of threads that can be wound as a layer around the layer C2;
the rubber sheath furthermore covers the inner layer C1 and/or separates the pairwise adjacent threads of the intermediate layer C2;
the rubber sheath covers practically the radially inner semi-circumference of each thread of the layer C3 in such a way that it separates the pairwise adjacent threads of this layer C3.

In the L+M+N construction according to the invention, the intermediate layer C2 preferably comprises six or seven threads and the cord according to the invention then has the following preferential characteristics (d₁, d₂, d₃, p₂ and p₃ in mm):

(i) 0.10<d₁<0.28;

(ii) 0.10<d₂<0.25;

(iii) 0.10<d₃<0.25;

(iv) M=6 or M=7;

(v) 5π(d₁+d₂)<p₂≦p₃<5π(d₁+2d₂+d₃);

(vi) the threads of said layers C2, C3 are wound in the same twist direction (S/S or Z/Z).

Preferably, characteristic (v) is such that p₂=p₃, in such a way that the cord is said to be “compact” considering moreover characteristic (vi) (threads of the layers C2 and C3 wound in the same direction).

According to characteristic (vi), all the threads of the layers C2 and C3 are wound in the same twist direction, that is to say either in the direction S (“S/S” arrangement) or in the direction Z (“Z/Z” arrangement). By winding the layers C2 and C3 in the same direction, it is advantageously possible in the cord according to the invention to minimize the friction between these two layers C2 and C3 and therefore the wear of the threads constituting them (since there is no longer crossed contact between the threads).

Preferably, said at least 85% of cords of at least one layer of the carcass reinforcement having in what is called the permeability test a flow rate of less than 20 cm³/min are layered cords of 1+M+N construction, that is to say that the inner layer C1 consists of a single thread.

Again advantageously, the (d₁/d₂) ratios are preferably set within given limits, according to the number M (6 or 7) of threads in the layer C2, as follows:

for M=6: 0.9<(d₁/d₂)<1.3;

for M=7: 1.3<(d₁/d₂)<1.6.

Too low a value of the ratio d₁/d₂ may be prejudicial to wear between the inner layer and the threads of the layer C2. As for too high a value, this may impair the compactness of the cord, for a barely modified definitive level of strength, and may also impair its flexibility. The greater rigidity of the inner layer C1 due to too high a diameter d₁ could moreover be prejudicial to the very feasibility of the cord during the cabling operations.

The threads of the layers C2 and C3 may have the same diameter or this may differ from one layer to the other. Preferably, threads of the same diameter (d₂=d₃) are used, especially to simplify the cabling process and to lower the costs.

The maximum number Nₘₐₓ of threads that can be wound as a single saturated layer C3 around the layer C2 depends of course on many parameters (diameter d₁ of the inner layer, number M and diameter d₂ of the threads of the layer C2, and diameter d₃ of the threads of the layer C3).

Said at least 85% of cords of at least one layer of the carcass reinforcement having in what is called the permeability test a flow rate of less than 20 cm³/min are preferably chosen from cords of 1+6+10, 1+6+11, 1+6+12, 1+7+11, 1+7+12 or 1+7+13 construction.

For a better compromise between strength, feasibility and flexural endurance of the cord, on the one hand, and penetrability by the rubber on the other hand, it is preferred for the diameters of the threads of the layers C2 and C3, whether identical or not, to be between 0.12 mm and 0.22 mm.

In such a case, it is preferred to have the following relationships satisfied:

0.14<d₁<0.22;

0.12<d₂≦d₃<0.20;

5<p₂≦p₃<12 (small pitches in mm) or else 20<p₂≦p₃<30 (large pitches in mm).

A diameter less than 0.19 mm helps reduce the level of stresses undergone by the threads during the large variations in curvature of the cords, while it is preferred to choose diameters greater than 0.16 mm in particular for thread strength and industrial cost reasons.

One advantageous embodiment consists for example in choosing p₂ and p₃ to be between 8 and 12 mm, advantageously with cords of 1+6+12 construction.

Preferably, the rubber sheath has an average thickness ranging from 0.010 mm to 0.040 mm.

In general, said at least 85% of cords of at least one layer of the carcass reinforcement having in what is called the permeability test a flow rate of less than 20 cm³/min according to the invention may be implemented with any type of metal thread, especially steel thread, for example carbon steel threads and/or stainless steel threads. It is preferred to use a carbon steel but of course it is possible to use other steels or other alloys.

When a carbon steel is used, its carbon content (% by weight of steel) is preferably between 0.1% and 1.2%, more preferably from 0.4% to 1.0%. These contents represent a good compromise between the required mechanical properties of the tire and the feasibility of the thread. It should be noted that a carbon content of between 0.5% and 0.6% makes such steels ultimately less expensive, as they are easier to draw. Another advantageous embodiment of the invention may also consist, depending on the intended applications, in using low carbon steels, for example having a carbon content of between 0.2% and 0.5%, especially because they have a lower cost and drawing is much easier.

Said at least 85% of cords of at least one layer of the carcass reinforcement having in what is called the permeability test a flow rate of less than 20 cm³/min according to the invention may be obtained by various techniques known to those skilled in the art, for example, in two steps: firstly a step in which the L+M intermediate structure or core (layers C1+C2) is sheathed via an extrusion head, which step is followed, secondly, by a final operation in which the N remaining threads (layer C3) are cabled or twisted around the thus sheathed layer C2. The problem of bonding in the uncured state posed by the rubber sheath, during possible intermediate winding and unwinding operations, may be solved in a manner known to those skilled in the art, for example by using an intermediate plastic film.

According to any one of the embodiments of the invention, the number of said at least at least 5% of cords comprising at least one strand consisting of adjacent textile multifilament yarns is preferably less than 3.

Within a carcass reinforcement layer, reinforcing elements are said to be adjacent in the context of the invention when they are separated from one another only by polymer compounds.

With more than three cords comprising at least one strand consisting of adjacent textile multifilament yarns, the risks of degradation or of visible defects on a tire would be greater, in particular because of the lower mechanical properties of said cords compared with those of said at least 85% of cords. This number of cords comprising at least one strand consisting of adjacent textile multifilament yarns is more preferably zero, that is to say that two of these layered cords comprising at least one strand consisting of textile multifilament yarns are never adjacent but always separated by at least one metal cord having in what is called the permeability test a flow rate of less than 20 cm³/min.

Advantageously according to the invention the diameter of said at least 5% of cords comprising at least one strand consisting of textile multifilament yarns is between 0.9 and 1.1 times the diameter of the metal cords having in what is called the permeability test a flow rate of less than 20 cm³/min.

Again advantageously, the breaking strength of said at least 5% of cords comprising at least one strand consisting of textile multifilament yarns is between 0.9 and 1.1 times the breaking strength of the metal cords having in what is called the permeability test a flow rate of less than 20 cm³/min.

According to one embodiment of the invention, the crown reinforcement of the tire is formed from at least two working crown layers of inextensible reinforcing elements, which are crossed from one layer to the other making angles of between 10° and 45° with the circumferential direction.

According to other embodiments of the invention, the crown reinforcement also includes at least one layer of circumferential reinforcing elements.

A preferred embodiment of the invention also provides for the crown reinforcement to be supplemented, radially to the outside, by at least one supplementary, protective layer consisting of elastic reinforcing elements oriented to the circumferential direction at an angle of between 10° and 45° and in the same sense as the angle made by the inextensible elements of the working layer that is radially adjacent thereto.

The protective layer may have an axial width smaller than the axial width of the narrowest working layer. Said protective layer may also have an axial width greater than the axial width of the narrowest working layer, such that it covers the edges of the narrowest working layer and, in the case of the radially upper layer being the narrowest, such that it is coupled, in the axial extension of the additional reinforcement, to the widest working crown layer over an axial width so as thereafter, axially to the outside, to be decoupled from said widest working layer by profiled elements having a thickness of at least 2 mm. The protective layer formed from elastic reinforcing elements may, in the abovementioned case, on the one hand, be optionally decoupled from the edges of said narrowest working layer by profiled elements having a thickness substantially less than the thickness of the profiled elements separating the edges of the two working layers and, on the other hand, have an axial width smaller or larger than the axial width of the widest crown layer.

According to any of the embodiments of the invention mentioned above, the crown reinforcement may also be supplemented, radially to the inside between the carcass reinforcement and the radially internal working layer closest to said carcass reinforcement, with a triangulation layer of inextensible metal reinforcing elements made of steel making, with the circumferential direction, an angle-of greater than 60° and in the same sense as that of the angle made by the reinforcing elements of the radially closest layer of the carcass reinforcement.

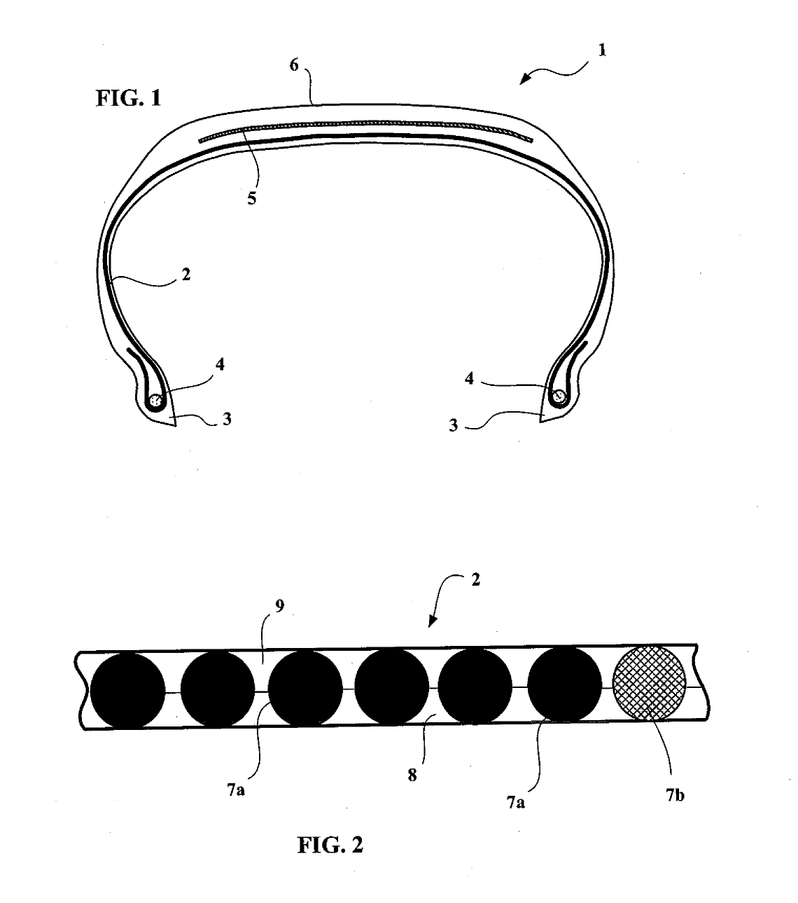

Other details and advantageous features of the invention will become apparent below from the description of exemplary embodiments of the invention, in particular with reference to FIGS. 1 to 6 which show:

FIG. 1, a meridional view of a diagram showing a tire according to one embodiment of the invention;

FIG. 2, a schematic representation in cross section of a carcass reinforcement layer of the tire shown in FIG. 1,

FIG. 3, a schematic representation of a cross-sectional view of a first example of a cord representing at least 85% of the metal reinforcing elements of at least one layer of the carcass reinforcement of the tire shown in FIG. 1,

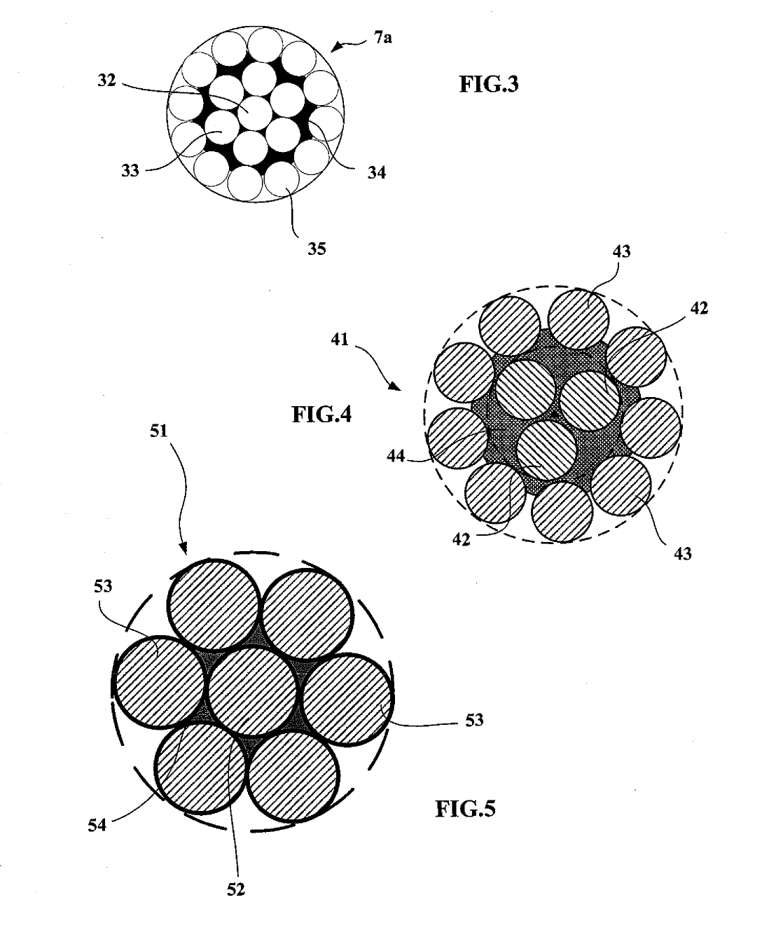

FIG. 4, a schematic representation of a cross-sectional view of a second example of a cord representing at least 85% of the metal reinforcing elements of at least one layer of the carcass reinforcement of the tire shown in FIG. 1,

FIG. 5, a schematic representation of a third example of a cord representing at least 85% of the metal reinforcing elements of at least one layer of the carcass reinforcement of the tire shown in FIG. 1, and

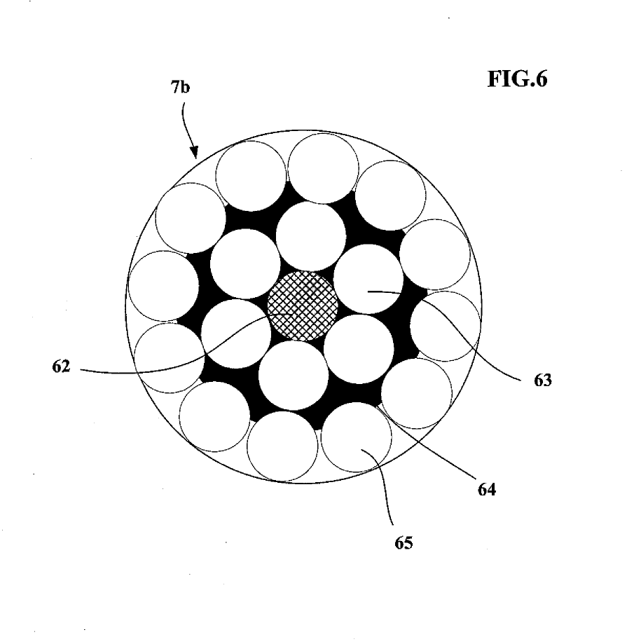

FIG. 6, a schematic representation of a layered cord comprising at least one strand consisting of textile multifilament yarns.

The figures have not been drawn to scale so as to make it simpler to understand them.

In FIG. 1, the tire 1, of 315/70 R 22.5 type, comprises a radial carcass reinforcement 2 anchored in two beads 3 around bead wires 4. The carcass reinforcement 2 is formed by a single layer of metal cords. The carcass reinforcement 2 is wrapped with a crown reinforcement 5 which is itself covered with a tread 6. The crown reinforcement 5 is formed, radially from the inside to the outside, from:
a first working layer formed from continuous non-wrapped inextensible metal cords 11.35 over the entire width of the ply, said cords being oriented at an angle of 18°;
a second working layer formed from continuous non-wrapped inextensible metal cords 11.35 over the entire width of the ply, said cords being oriented at an angle of 18° and crossed with the metal cords of the first working layer; and
a protective layer formed from elastic metal cords 6×35.

All these layers constituting the crown reinforcement 5 have not been shown in detail in the figures.

FIG. 2 illustrates a cross-sectional schematic representation of a carcass reinforcement layer 2 according to the invention, the cross section being in a plane perpendicular to the direction of orientation of the reinforcing elements. This layer consists of a set of cords 7a, 7b oriented parallel to one another and maintained between two layers 8, 9 of rubber compound, called calendering layers.

The reinforcing elements 7a, shown as filled circles in FIG. 2, represent the at least 85% of non-wrapped metal cords having in what is called the permeability test a flow rate of less than 20 cm³/min and, in the present case, non-wrapped cords having at least two layers, at least an inner layer being sheathed with a layer which consists of a polymeric composition, such as a crosslinkable or crosslinked rubber composition. The element 7b, shown as a cross-hatched circle in FIG. 2, represents the at least 5% of layered cords comprising at least one strand consisting of textile multifilament yarns.

FIG. 3 illustrates a schematic representation of the cross section through a carcass reinforcement cord 7a of the tire 1 shown in FIG. 1. This cord 7a is a non-wrapped layered cord of 1+6+12 construction, consisting of a central core formed by a thread 32, an intermediate layer formed from six threads 33 and an outer layer formed from twelve threads 35.

The cord has the following characteristics (d and p in mm):

1+6+12 construction;

d₁=0.20;

d₂=0.18;

p₂=10;

d₃=0.18;

p₃=10;

(d₂/d₃)=1;

where d₂ and p₂ are, respectively, the diameter and the helix pitch of the intermediate layer and d₃ and p₃ are, respectively, the diameter and the helix pitch of the threads of the outer layer.

The core of the cord consisting of the central core formed from the thread 32 and from the intermediate layer formed from the six threads 33 is sheathed by a rubber composition 34 based on an unvulcanized diene elastomer (in the uncured state). Sheathing of the core, consisting of the thread 32 surrounded by the six threads 33, is carried out using an extrusion head, followed by a final operation of twisting or cabling the twelve threads 35 around the core thus sheathed.

The cord 7a has in what is called the permeability test, as described above, a flow rate equal to 0 cm³/min and therefore less than 2 cm³/min. Its penetration by the rubber composition is equal to 95%.

The cord 7a has a diameter of 0.95 mm.

The elastomer composition constituting the rubber sheath 34 is made from a composition as described above and has, in the present case, the same formulation, based on natural rubber and carbon black, as that of the calendering layers 8, 9 of the carcass reinforcement that the cords are intended to reinforce.

FIG. 4 illustrates a schematic representation of the cross section through another carcass reinforcement cord 41 that can be used in a tire according to the invention as a replacement for the cord of FIG. 3, that is to say as said at least 85% of non-wrapped cords having at least two layers, at least one inner layer being sheathed with a layer consisting of a polymer composition. This cord 41 is a non-wrapped layered cord of 3+9 construction consisting of a central core formed from a cord consisting of three threads 42 twisted together and an outer layer formed from nine threads 43.

This cord has the following characteristics (d and p in mm):

3+9 construction;

d₁=0.18;

pₜ=5;

(d₁/d₂)=1;

d₂=0.18;

p₂=10,

where d₁ and p₁ are, respectively, the diameter and the helix pitch of the threads of the central core and d₂ and p₂ are, respectively, the diameter and the helix pitch of the threads of the outer layer.

The central core consisting of a cord formed from three threads 42 was sheathed with a rubber composition 44 based on an unvulcanized diene elastomer (in the uncured state). The sheathing of the cord 42 is carried out by an extrusion head, followed by a final operation of cabling the nine threads 43 around the core thus sheathed.

The cord 41 has in what is called the permeability test, as described above, a flow rate equal to 0 cm³/min and therefore less than 2 cm³/min. Its penetration by the rubber composition is equal to 95%.

The cord 41 has a diameter of 1.0 mm.

FIG. 5 illustrates a schematic representation of the cross section through another carcass reinforcement cord 51 that can be used in a tire according to the invention as a replacement for the cord of FIG. 3, that is to say as said at least 85% of non-wrapped cords having at least two layers, at least one inner layer being sheathed with a layer consisting of a polymer composition. This cord 51 is a non-wrapped layered cord of 1+6 construction consisting of a central core formed from a thread 52 and an outer layer formed from six threads 53.

This cord has the following characteristics (d and p in mm):

1+6 construction;

d₁=0.200;

(d₁/d₂)=1.14;

d₂=0.175;

p₂=10,

where d₁ is the diameter of the core and d₂ and p₂ are, respectively, the diameter and the helix pitch of the threads of the outer layer.

The central core consisting of the thread 52 was sheathed with a rubber composition 54 based on an unvulcanized diene elastomer (in the uncured state). The sheathing of the thread 52 is carried out by an extrusion head, followed by a final operation of cabling the six threads 53 around the core thus sheathed.

The cord 51 has in what is called the permeability test, as described above, a flow rate equal to 0 cm³/min and therefore less than 2 cm³/min. Its penetration by the rubber composition is equal to 95%.

The cord 51 has a diameter of 0.75 mm.

FIG. 6 illustrates a schematic representation of the cross section of a carcass reinforcement cord 7b of the tire 1 shown in FIG. 1. This cord 7b is a non-wrapped layered hybrid cord of 1+6+12 construction, consisting of a central core formed from a thread 61 consisting of multifilament aromatic polyamide yarns, an intermediate layer formed from six metal threads 63 and an outer layer formed from twelve metal threads 65.

The central core is a 22/2/1 S200 aromatic polyamide cord.

It has the following characteristics (d and p in mm):

structure 1+6+12;

d₁=0.22;

d₂=0.18;

p₂=10;

d₃=0.18;

p₃=10;

(d₂/d₃)=1,

where d₂ and p₂, are, respectively, the diameter and the helix pitch of the intermediate layer and d₃ and p₃ are, respectively, the diameter and the helix pitch of the threads of the outer layer.

The central member of the cable consisting of the central core formed from the aromatic polyamide thread 62 and of the intermediate layer formed from the six threads 63 is sheathed with a rubber composition 64 based on an unvulcanized diene elastomer (in the uncured state). The sheathing of the core consisting of the thread 62 surrounded by the six threads 63 is carried out by an extrusion head and is followed by a final operation of twisting or cabling the twelve threads 65 around the core thus sheathed.

In FIG. 6, the sheath is represented as reaching the core of the cord 7b. It thus makes it possible to avoid any rubbing between the threads 63 of the intermediate layer, but the layer does not penetrate the multifilament yarns of the thread 62 so as to maintain its draining function. The thread 62 was coated beforehand, in a known manner, with an adhesive so as to promote its adhesion to the rubber composition 64 that penetrates right to the core while the tire is being cured, said adhesive furthermore acting as a barrier and preventing penetration of the rubber composition between the filaments of the thread 62.

The cord 7b is therefore similar to the cord 7a of FIG. 3 but differs therefrom by its core which is not a metal thread but a thread or strand consisting of aromatic polyamide multifilament yarns.

The cord 7b has a diameter of 0.95 mm.

The carcass reinforcement layer of the tire 1 produced in accordance with these FIGS. 1, 2 and 6 comprises 87% of reinforcing elements 7a and 13% of reinforcing elements 7b.

As mentioned previously, other types of cords 7b, not shown in the figures, may be used. In particular, these may be textile cords. To give an example, the cord 7b may be a 330×2 315/315 aromatic polyamide cord. Such a cord consists of two strands of 330 aromatic polyamide filaments each strand being twisted with 315 twists per meter, and finally the two strands being assembled with a twist equivalent to 315 turns per meter in the opposite direction to that of the strands. The cord then passes via an adhesive coating step so as to deposit an adhesive that promotes the adhesion between said cord and the elastomeric compounds of the calendering layers. Such a cord has a diameter of 1.0 mm.

A carcass reinforcement layer produced in accordance with the invention with such a cord would comprise 94% of reinforcing elements 7a and 6% of reinforcing elements 7b.

Other examples of textile cords, also not shown in the figures, may be used for the invention. These may, for example, be 252×3 265/265 aromatic polyamide cords that have a diameter of 0.96 mm, or else 167×2×2 210/210 polyethylene naphthalate cords having a diameter of 0.94 mm.

Trials were carried out on tires produced according to the invention as shown in FIGS. 1, 2, 3 and 6, while other trials were carried out on what are called control tires.

The control tires differ from the tires according to the invention by a carcass reinforcement in which the reinforcing elements are cords such as those shown in FIG. 3, but they do not include a sheathing layer. The carcass reinforcement also does not comprise layered cords comprising at least one strand consisting of textile multifilament yarns, such as that of the invention.

None of the tires thus produced, whether tires according to the invention or else control tires, showed any visible defect imputable to the presence of air or moisture.

Rolling drum endurance trials were carried out on a test machine imposing a load of 4415 daN on the tires, which were run at a speed of 40 km/h, with oxygen-doped inflation of the tires. The trials were carried out on the tires according to the invention under conditions identical to those applied to the control tires. The running tests were stopped as soon as the carcass reinforcement of the tires showed degradation.

The trials thus carried out showed that the distances travelled during each of these tests are favorable for the tires according to the invention, which ran for 300 000 km, whereas the control tires travelled only 250 000 km.

Other rolling endurance trials on a vehicle driving axle were carried out by imposing a load of 3680 daN on the tires, which were run at a speed of 40 km/h, with a tire pressure of 0.2 bar. The trials were carried out on the tires according to the invention under conditions identical to those applied to the control tires. The running tests were carried out over a distance of 12 000 km or were stopped as soon as the carcass reinforcement of the tires showed degradation.

The trials thus carried out showed that the distances travelled during each of these tests on the tires according to the invention could always reach around 12 000 km, whereas the control tires travelled at most only 10 000 km.

Furthermore, other types of tire were manufactured. These tires differ from the tires according to the invention by a carcass reinforcement comprising only cords 7a as shown in FIG. 3.

It turns out that most of these tires show visible defects on the sidewalls owing to the presence of air pockets that make the tires non-marketable. By producing tires in accordance with the invention it is possible to considerably reduce the number of non-marketable tires due to this type of defect in comparison with tires in which the carcass reinforcement comprises only cords as shown in FIG. 3.

1. A tire having a radial carcass reinforcement, including at least one layer of reinforcing elements, said tire comprising a crown reinforcement, which is itself covered radially with a tread, said tread being joined to two beads via two sidewalls, wherein at least 85% of the reinforcing elements of at least one layer of the carcass reinforcement are non-wrapped metal cords having in what is called the permeability test a flow rate of less than 20 cm³/min, and wherein at least 5% of the reinforcing elements of said at least one layer of the carcass reinforcement are cords comprising at least one strand consisting of textile multifilament yarns.

2. The tire according to claim 1, wherein said at least 85% of the metal reinforcing elements of at least one layer of the carcass reinforcement having in what is called the permeability test a flow rate of less than 20 cm³/min are cords having at least two layers and wherein at least one inner layer is sheathed with a layer including a polymeric composition such as a crosslinkable or crosslinked rubber composition.

3. The tire according to claim 1, wherein, the cords have in what is called the permeability test a flow rate of less than 10 cm3/min.

4. A tire having a radial carcass reinforcement including at least one layer of reinforcing elements, said tire comprising a crown reinforcement, which is itself covered radially with a tread, said tread being joined to two beads via two sidewalls, wherein at least 85% of the metal reinforcing elements of at least one layer of the carcass reinforcement are non-wrapped cords having at least two layers, at least one inner layer being sheathed with a layer including a polymeric composition such as a crosslinkable or crosslinked rubber composition, and wherein at least 5% of the reinforcing elements of said at least one layer of the carcass reinforcement are cords comprising at least one strand including textile multifilament yarns.

5. The tire according to claim 1 or 4, wherein said at least 5% of the reinforcing elements of said at least one layer of the carcass reinforcement are textile cords.

6. The tire according to claim 5, wherein the textile cords represent at most 10% of the reinforcing elements of said at least one layer of the carcass reinforcement.

7. The tire according to claim 1 or 4, wherein said at least 5% of the reinforcing elements of said at least one layer of the carcass reinforcement are hybrid cords comprising at least one metal strand.

8. The tire according to claim 7, wherein said at least 5% of the reinforcing elements of said at least one layer of the carcass reinforcement are layered cords, wherein the core comprises at least one strand or thread including textile multifilament yarns and wherein the strands of the intermediate and/or outer layers are metal strands.

9. The tire according to claim 7, wherein the hybrid cords represent at least 10% of the reinforcing elements of said at least one layer of the carcass reinforcement.

10. The tire according to claim 7, wherein the hybrid cords are cords having at least three layers and wherein at least one intermediate layer is sheathed with a layer including a polymeric composition such as a crosslinkable or crosslinked rubber composition.

11. The tire according to claim 1 or 4, wherein said at least 85% of the metal reinforcing elements of at least one layer of the carcass reinforcement are layered metal cords of [L+M] or [L+M+N] construction, comprising a first layer C1 having L threads of diameter d1 where L ranges from 1 to 4, surrounded by at least one intermediate layer C2 having M threads of diameter d2 wound together in a helix with a pitch p2 where M ranges from 3 to 12, said layer C2 being optionally surrounded by an outer layer C3 of N threads of diameter d3 wound together in a helix with a pitch p3 where N ranges from 8 to 20, and wherein a sheath consisting of a crosslinkable or crosslinked rubber composition based on at least one diene elastomer covers, in the [L+M] construction, said first layer C1 and, in the [L+M+N] construction, at least said layer C2.

12. The tire according to claim 11, wherein the diameter of the threads of the first layer C1 is between 0.10 and 0.5 mm, and wherein the diameter of the threads of the layers C2, C3 is between 0.10 and 0.5 mm.

13. The tire according to claim 11, wherein, said threads of the outer layer C3 are helically wound with a helix pitch of between 8 and 25 mm.

14. The tire according to claim 2 or 4, wherein the diene elastomer is selected from the group consisting of polybutadienes, natural rubber, synthetic polyisoprenes, butadiene copolymers, isoprene copolymers, and blends of these elastomers.

15. The tire according to claim 2 or 4, wherein the crosslinkable or crosslinked rubber composition based on at least one diene elastomer has, in the crosslinked state, a secant modulus in extension of less than 20 MPa.

16. The tire according to claim 2, wherein said rubber composition is based on at least one diene elastomer.

17. The tire according to claim 1, wherein the cords have in what is called the permeability test a flow rate of less than 2 cm³/min.

18. The tire according to claim 10, wherein said rubber composition is based on at least one diene elastomer.

19. The tire according to one of claim 2 or 4, wherein the crosslinkable or crosslinked rubber composition based on at least one diene elastomer has, in the crosslinked state, a secant modulus in extension of less than 12 MPa.
